(19) United States
(12) Patent Application Publication
(10) Pub. No.: US 2014/0227495 A1
(43) Pub. Date: Aug. 14, 2014

(54) PACKAGING LAMINATE

(71) Applicant: Martin Rothenbuehier, Langnau im Emmental (CH)

(72) Inventor: Martin Rothenbuehier, Langnau im Emmental (CH)

(73) Assignee: AMCOR FLEXIBLES KREUZLINGEN LTD., Kreuzlingen (CH)

(21) Appl. No.: 14/125,162

(22) PCT Filed: Jun. 7, 2012
(86) PCT No.: PCT/EP2012/002427

§ 371 Date: Mar. 31, 2014

(30) Foreign Application Priority Data
Jun. 10, 2011 (EP) 11004755.2

(51) Int. Cl. B65D 81/24; B32B 37/12; B32B 27/10

(52) U.S. Cl. CPC B65D 81/24; B32B 27/10; B32B 37/12; B32B 2255/12; B32B 2255/10; B32B 2307/732; B32B 2307/7244; B32B 2307/7248; B32B 2255/205; B32B 2255/26; B32B 2255/24; B32B 2553/00; B32B 2037/1276
USPC 428/209; 428/448; 428/344; 428/343; 428/425.1; 428/215; 156/325

(57) ABSTRACT

In the case of a packaging laminate with good oxygen and aroma barrier properties comprising paper and a film of plastic metallized on one side, the paper is connected to the side of the film of plastic that has the metallization by way of a layer of laminating agent containing at least a water-based silicate.

The invention relates to a packing laminate of paper and a plastics material film metallized on one side and with an improved oxygen and aroma barrier, the paper being joined by way of a layer of laminating agent to the side of the plastics material film which has the metallization. The invention further relates to a method of producing the aforesaid packing laminate.

Packing laminates of paper and a plastics material film are known. In the case of a packing produced from the laminate the paper forms the outer side which is optionally printed. The plastics material film forming the inner side is used for sealing against the inner side of the same or a different laminate. Conventional adhesives, for example based on polyurethane or acrylate, are used as a laminating agent. In order to reduce the passage of oxygen and aromatic substances through the laminate, a suitable barrier layer is usually arranged between the paper and the plastics material film. In order to achieve a high barrier effect the arrangement of a metallic foil, in particular an aluminium foil, is known. An inexpensive conventional metallization, for example a metallization with aluminium, provides only a limited protection against the passage of oxygen and aromas. For an optimum protection, therefore, as well as the metallization, at least one further barrier layer involving additional costs, such as for example a film of an ethylene vinyl alcohol (EVOH) copolymer, is necessary.

The object of the invention is to make available an inexpensive packing laminate of paper and a plastics material film with a good oxygen and aroma barrier.

In order to attain the object according to the invention, the procedure in the case of a packing laminate of the type specified in the introduction is that the layer of laminating agent contains at least one water-based silicate.

The packing laminate of the type specified in the introduction thus preferably contains a layer of laminating agent of water-based silicates and additives which are miscible with the water-based silicates and which reduce the brittleness of the resulting laminated layer.

All qualities of paper are suitable as the paper. The paper can be unprinted or printed.

Examples of aqueous silicate solutions which are suitable for the production of the packing laminate according to the invention include sodium silicate, potassium silicate, lithium silicate, ammonium silicate or tetramethylammonium silicate, alone or in the form of a mixture of at least two of the silicates specified above. The silicate solutions can contain further compounds compatible with the silicates used. With these further compounds the intention is, in particular, to counteract the brittleness of the laminated layer which occurs as a result of the use of the silicates. The aim is to retain the flexibility of the laminated layer by additives of substances which are miscible with water-based silicates. Suitable additives are humectants, such as:

polyols, for example mannitol or sorbitol,

monosaccharides, for example glucose or fructose,

disaccharides, for example sucrose or lactose,

oligosaccharides (from 3 to 10 monosaccharides), for example melezitose,

polysaccharides (more than 10 monosaccharides), for example amylose or cellulose,

cyclic oligosaccharides, for example cyclodextrin,

as well as all modified saccharides specified above, for example glusosamine, fructose-1,6-bisphosphate or chitin,

salts of organic acids, for example magnesium acetate or potassium citrate,

salts of inorganic acids, for example lithium chloride or ammonium phosphate.

The flexibility of the laminated layer can also be achieved with other additives which are not necessarily known as humectants, such as dispersions or soluble resins of ethylene vinyl acetate (EVA) copolymers, polyethylenimine (PEI) or polyurethane (PU), or acryl dispersions.

A preferred metallization comprises aluminium or an aluminium alloy.

The plastics material film provided on one side with the metallization can be any film which is preferably capable of being sealed against itself. Preferred plastics material films are films from non-oriented, mono-oriented or biaxially oriented polypropylene (PP, OPP), films from partially crystalline polyethylene terephthalate (PETP), mono-oriented or biaxially oriented films of polyamide (OPA) as well as films of polylactide (PLA), cyclic olefin copolymers (COC) and cellophane.

As well as excellent adhesion both to the paper and to the metallized plastics material film, the use according to the invention of water-based silicates as a laminating agent leads to a considerable improvement in the oxygen and aroma barrier of the laminate.

It is preferable for the paper to have a thickness of from 10 to 150 μm and for the plastics material film to have a thickness of from 1 to 500 μm.

The packing material according to the invention is suitable, in particular, for the production of sealed bags for packing foodstuffs and technical products which are susceptible to moisture.

The water-based silicates considerably increase the oxygen barrier properties of the packing laminate on the one hand, and they also allow a strong adhesive join between a paper layer and a metallized plastics material film on the other hand, and so the water-based silicates are particularly suitable as a laminating medium in laminating agent layers of composites containing a paper layer and a metallized plastics material foil. In this respect the water-based silicates (water glass) in the laminating agent layer of packing laminates of paper and metallized plastics material foil serve as a barrier adhesive medial layer.

The water vapour barrier properties of a laminate of a paper layer and a metallized plastics material film are not substantially affected by a laminating agent layer of silicate. The properties of the water barrier and the aroma barrier have only an approximate relationship.

The properties of the aroma barrier of the laminate according to the invention have been tested as follows:

Clove oil (a highly odour-intensive liquid) is introduced into a bag of a packing laminate according to the invention and, for comparison, also with other paper/metallized plastics material foil laminates without silicate lamination and is subjected to a sniffing test after a few days. The result was that metallization of plastics material foils prevents the migration of aroma components only slightly, but that the silicate laminations improve the aroma barrier effect by several days.

The object of the method is achieved by adhesion or lamination of the paper layer with the side of the plastics material film having the metallization by the use of a water-based silicate, optionally containing additives to improve the flexibility of the resulting layer of laminating agent.

In the case of a method suitable for the continuous production of the laminate according to the invention a web of paper is wound off from a first roll, is coated with the laminating agent in an application device and is supplied to a laminating device. At the same time a metallized plastics material film is wound off from a second roll and is supplied directly to the laminating device. The web of paper and the metallized plastics material film are joined in the laminating device to form the laminate. The laminate emerging from the laminating device passes through a drying device and is then wound onto a third roll. The coating with laminating agent can also be carried out on the metallized side of the plastics material film. The application of the laminating agent can be carried out with any methods known in the prior art, such as for example by printing or by spraying.

Further advantages, features and details of the invention are evident from the following description of preferred embodiments as well as with reference to the drawing. In the drawing:

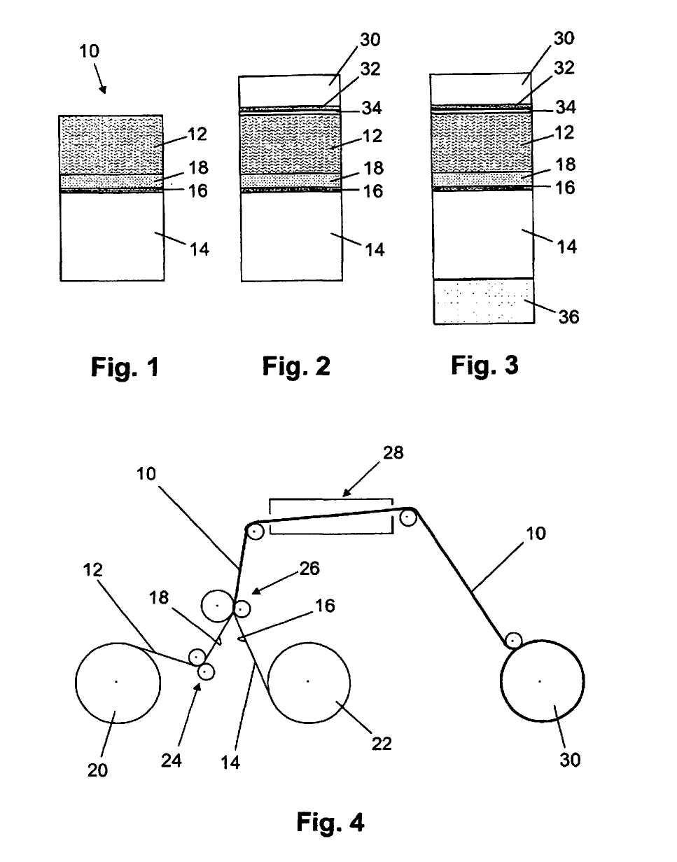

FIG. 1 shows diagrammatically the structure of a layer of a packing laminate;

FIG. 2 shows diagrammatically a second embodiment based upon the packing laminate of FIG. 1;

FIG. 3 shows diagrammatically a third embodiment based upon the packing laminate of FIG. 1, and

FIG. 4 shows diagrammatically a method sequence for producing the packing laminate shown in FIG. 1.

As shown in FIG. 1, a packing laminate 10 has a paper 12 and a plastics material film 14 coated on one side with metallization 16. The paper 12 and the plastics material film 14 are joined by way of an interposed laminated layer 18 to form the laminate 10. In this case the metallization 16 is arranged on the side of the plastics material film 14 laminated against the paper 12.

In the case of a second embodiment illustrated in FIG. 2 and based upon the packing laminate of FIG. 1, a further plastics material film 30 of PETP for example is provided with a printing 32 and is connected to the paper 12 by means of an adhesive layer 34.

In the case of a third embodiment illustrated in FIG. 3 and based upon the packing laminate of FIG. 1, the side of paper is arranged in accordance with FIG. 2. In addition, the metallized plastics material foil 14 is coated with a further plastics material layer 36 provided as a sealing layer. This further plastics material layer can be joined to the plastics material layer 14 by extrusion coating or lamination.

FIG. 4 shows a method which is suitable for the production of the packing laminate 10 illustrated in FIG. 1 and which is known from the prior art and is described below.

The paper 12 present in the form of a web is wound off from a first roll 20 and is coated on one side with the laminated layer 18 in a following application station 24. At the same time the plastics material film 14 present in the form of a web and already metallized on one side beforehand is wound off from a second roll 22 and is supplied to a lamination station 26 together with the paper 12 provided with the laminated layer 18 and they are joined together. In this case the metallization 16 forms the side of the plastics material film 14 laminated against the paper 12. The packing laminate 10 formed in the lamination station 26 is subsequently conveyed through a drying station 28 for drying the laminated layer 18 and is then wound onto a third roll 30.

Table 1 indicates OTR measurement values for various metallized plastics material foils, which can be used as a starting material for the packing laminate according to the invention, as well as for various packing laminates according to the invention. In addition, the Table contains as the last measurement value (reference value) the measured OTR value of a laminate which contains a PUR adhesive as a layer of laminating agent instead of a water-based silicate. The OTR values determine the oxygen barrier and designate the oxygen transfer rate, these measurement values being obtained at 23° C. and at a relative moisture of 75%. The OTR values are indicated in cm³/(m²×24 h×bar).

Table 1 clearly shows that packing laminates according to the invention with a layer of laminating agent containing a water-based silicate have substantially lower OTR values as compared with an only metallized plastics material film on the one hand or with respect to a packing material of paper and a plastics material film metallized on one side, which are joined to each other by way of a layer of PUR adhesive, and thus display a substantially improved barrier effect as compared with oxygen.

The metallized base films (M-bPP and M-OPP) used as a starting material have an average OTR barrier which can be improved with the silicate lamination to form a high barrier for oxygen. In general, the better the metallized surface is wetted with the water-based silicate, the greater the OTR barrier is increased by the silicate lamination.

TABLE 1
Oxygen barrier (OTR, oxygen transfer rate) at 23° C. and
75% rH in cm³/(m² × 24 h × bar)

| | | OTR |
|---|---|---|
| Structure | Adhesion | @ 23/75 |
| M-bPP 28 μm (starting material) | — | 57 · 5 |
| M-OPP 20 μm, specification value: OTR <50 | — | 45 |
| (starting material) | | |
| Paper 50 μm/water glass 5 · 8%/M-OPP 20 μm | fibre tear | 0 · 1 |
| Paper 50 μm/water glass 4 · 3%/M-OPP 20 μm | fibre tear | 0 · 3 |
| Paper 50 μm/(90% water glass, 10% PEI) | fibre tear | 0 · 3 |
| 4 · 3 μm/M-OPP 20 μm | | |
| Paper 50 μm/(90% water glass, 10% sugar) | fibre tear | 0 · 3 |
| 6 · 5 μm/M-bPP 28 μm | | |
| Paper 50 μm/PUR adhesive 4 · 0 μm/M-bPP | fibre tear | 8 · 2 |
| 28 μm (reference value) | | |

M-bPP blow moulded polypropylene film metallized with aluminium
M-OPP biaxially oriented polypropylene film metallized with aluminium
PEI polyethylenimine (product name Aquatack ® 1467, a water-based primer dispersion completely free of solvent)

The adhesion of a laminate containing a paper layer is usually evaluated by means of a fibre tear. A fibre tear means in this case that the paper layer per se starts to tear. If the adhesion of the paper layer is very good, a fibre tear will occur, otherwise—i.e. in the case of poorer adhesion—the laminate layers will become detached without a fibre tear in the paper layer. In Table 1 the laminate structure for which a fibre tear occurs is indicated in each case. The adhesion between the metallized plastics material film 14 and the paper 12 is excellent in the case of the laminates according to the invention, which are laminated with a water-based silicate, as also in the case of the comparative example with a PUR adhesive, i.e. a fibre tear occurs in each case.

1-12. (canceled)

13. A packing laminate comprised of paper and a plastics material film metallized on one side, wherein the paper is joined by way of a layer of laminating agent to the side of the plastics material film having the metallization and wherein the layer of laminating agent contains at least one water-based silicate.

14. The packing laminate of claim 13, wherein the plastics material film is a non-oriented, mono-oriented or biaxially oriented film of polypropylene (OPP), a film from partially crystalline polyethylene terephthalate (PETP), a mono-oriented or biaxially oriented film of polyamide (OPA) or a film of polylactide (PLA), cyclic olefin copolymers (COC) or cellophane.

15. The packing laminate of claim 13, wherein the plastics material film is capable of being sealed.

16. The packing laminate of claim 13, wherein the plastics material film is capable of being sealed against itself.

17. The packing laminate of claim 13, wherein the plastics material film is extrusion-coated or laminated with a sealing layer.

18. The packing laminate of claim 13, wherein the paper is joined by means of an adhesive layer to a further plastics material film.

19. The packing laminate of claim 13, wherein the paper is joined by means of an adhesive layer to a further plastics material provided with printing.

20. The packing laminate of claim 13, wherein the layer of laminating agent contains sodium silicate, potassium silicate, lithium silicate, ammonium silicate or tetramethylammonium silicate, or a mixture thereof.

21. The packing laminate of claim 13, wherein the layer of laminating agent contains at least one substance selected from the group consisting of polyols; monosaccharides; disaccharides; oligosaccharides; polysaccharides; cyclic oligosaccharides; salts of organic and inorganic acids; dispersions and soluble resins of ethylene vinyl acetate (EVA) copolymers, polyethylenimines (PEI) and polyurethanes (PU); and acryl dispersions.

22. The packing laminate of claim 13, wherein the metallization comprises aluminum or an aluminum alloy.

23. The packing laminate of claim 13, wherein the paper has a thickness of from 10 to 150 μm and the plastics material film has a thickness of from 1 to 500 μm.

24. A method of producing a packing laminate with high oxygen and aroma barrier properties from a paper layer and a plastics material film metallized on one side, comprising joining the paper layer by way of a layer of laminating agent to the side of the plastics material film having the metallization, wherein the adhesion or lamination of the paper layer with the side of the plastics material film having the metallization is carried out by a water-based silicate, optionally additionally containing additives to improve the flexibility of the resulting layer of laminating agent.

25. The method of claim 24, wherein one or more additives are used and the additives are selected from the group consisting of polyols; monosaccharides; disaccharides; oligosaccharides; polysaccharides; cyclic oligosaccharides; salts of organic and inorganic acids; dispersions and soluble resins of ethylene vinyl acetate (EVA) copolymers, polyethylenimines (PEI) and polyurethanes (PU); and acryl dispersions and mixtures thereof.

26. The method of claim 24, wherein the water-based silicate is a sodium silicate, potassium silicate, lithium silicate, ammonium silicate or tetramethylammonium silicate or a mixture thereof.
